(19) United States
(12) Patent Application Publication
(10) Pub. No.: US 2008/0116699 A1
(43) Pub. Date: May 22, 2008

(54) UNIVERSAL THREE-PART ROSETTE

(76) Inventors: Ulrich Karcher, Wimpfen (DE); Aniko Schmidt, Bad Rappenau (DE)

Correspondence Address: AKERMAN SENTERFITT, P.O. BOX 3188, WEST PALM BEACH, FL, 33402-3188, US

(21) Appl. No.: 11/562,736

(22) Filed: Nov. 22, 2006

(51) Int. Cl. E05B 3/06; E05B 15/02; E05B 17/00

(52) U.S. Cl. 292/336.3; 292/357; 70/466

(57) ABSTRACT

A universal rosette for mounting a door handle includes a mounting base (10) adapted to be attached to a door leaf, a base member (20) adapted to be attached to the mounting base (10), and a screw-over ring (30) for screwing onto the mounting base (10). The mounting base has a planar surface on a first side facing the door leaf, a central opening (12), a ring part (14) surrounding the central opening (12), a plurality of screw openings (16′, 16″) with different shapes formed in the ring part (14), and two stop pins (18) formed on the ring part (14) and on a second side opposite to the first side. The base member has four accommodation openings (22) for accommodating the stop pins (28) vertically or horizontally. A mounting help (50) has a central square opening (52) for positively mounting on a square pin sitting in a lock casing and two openings (54) in radial spacing to the central opening (52) For accommodating the stop pins (18) of the mounting base (10).

### FIELD OF THE INVENTION

The present invention relates to a door hardware, and more specifically, to a three-part rosette for mounting a door handle, which can be used universally.

### BACKGROUND OF THE INVENTION

Rosettes or escutcheons for mounting a door handle are normally used in pairs which are fixed to each side of the door respectively. Conventional two-part rosettes or escutcheons have the problem that they are difficult to mount and difficult to repair or replace because during mounting, the door handle must be turned against the support spring when directly screwing the base member in order to apply the fixing screws to the otherwise concealed area, which requires at least three hands. It is noted that the door handles are mounted on the base member in a way that they are limited to be rotatable about 90°, whereby the rotation limit is reached by a brake buffer and a return spring is provided to guarantee a constantly horizontal orientation of the door handle.

Three-part rosettes or escutcheons have been developed to solve the above problem. The three-part rosettes or escutcheons provide a mounting base, which can be easily preassembled in the intended position, thus facilitating the mounting of the rosettes or escutcheons.

European patent EP 0 942 121 B1 (incorporated to the instant application by reference) has described such a three-part rosette or escutcheon, which has a mounting base or plate, a base member or a carrier plate, and a screw-over ring. The mounting base has a central opening with an elliptical contour, two protruding assembly tappets formed on a side facing the door, and two stop pins formed on the other side facing the base member. These three parts serve to mount a door opener over a square pin for operating a lock trap. For fastening, two bores diametric with respect to the square pin are provided in the lock casing, which are also incorporated in the door rail and accommodate the two protruding assembly tappets of the mounting base. The bores also go cross the door, namely cross the door leaf and the lock casing. It is, thus, possible to insert a mounting base on each side of the door and to screw together these two mounting bases with each other. The base member can then be applied on the stop pins of the mounting base and secured with the screw-over ring in a simple way.

However, this construction cannot be used for most of the US lock casings because the bores in the lock casing for the fastening screws have different locations. For example, in a lock casing of the company Accurate the bores are arranged vertically (not horizontally as in Europe) and have a radial extension as elongated holes, whereas in lock casings produced by other manufactures the bores are arranged under different beveled angles with respect to the vertical direction.

### SUMMARY OF THE INVENTION

Accordingly, the object of the present invention is to develop a universal solution which combines the advantages of the existing three-part rosette with a simple mountableness. More specifically, the object of the present invention is to provide a universal three-part door handle rosette that is compatible with all available locks on the American market as well as other markets.

To achieve the above object, the present invention provides a universal rosette for mounting a door handle, which includes a mounting base adapted to be attached to a door leaf, a base member adapted to be attached to the mounting base, and a screw-over ring for screwing onto the mounting base. The mounting base has a planar surface on a first side facing the door leaf, a central opening, a ring part surrounding the central opening, a plurality of screw openings with different shapes formed in the ring part, and two stop pins formed on the ring part and on a second side opposite to the first side. The base member has accommodation openings for accommodating the stop pins vertically or horizontally.

The advantage for the mounting base to have a planar surface on the side facing the door is that the mounting base can be assembled to different locks with bores having different angles and distances. In this way, the mounting base is not limited to certain types of locks and can thus be used universally.

The advantage of a plurality of screw openings having different shapes in the mounting base is that the mounting base can now be used for a variety of locks with different arrangement of bores in the lock casing.

In order to be compatible with different alignments, the screw openings includes at least one small through opening for a vertical or horizontal alignment and at least one arch-shaped elongated opening for an angular alignment.

In a preferred embodiment, the arch-shaped elongated opening covers an angular region of preferred 30° to 60°.

The widths of the screw openings are so designed that a mounting tolerance for a through screw joint is provided.

The screw openings are mirror symmetrically arranged with respect to the central opening in order to attach a pair of mounting bases to the inside and outside of a door leaf.

In contrast to the circular stop pins provided in EP 0 942 121 B, in the present invention the stop pins are oblong in the peripheral direction. This has the advantage of providing higher strength against rotation loads and better stability.

In a preferred embodiment, the base member has four accommodation openings offset 90° with one another, so as to be able to accommodate the stop pins in both vertical and horizontal orientation.

Since the mounting base no longer has bearing tappets as disclosed EP 0 942 121 B, a mounting help is provided according to the present invention for assisting the mounting of the mounting base to the door leaf. The mounting help is formed with a central square opening for positively mounting on a square pin sitting in a lock casing and two openings in radial spacing to the central opening for accommodating the stop pins of the mounting base. This will allow a simple centering of the two mounting bases to be mounted to a door leaf from both sides.

In order to additionally enable a transient connection between the mounting help and the mounting base, a removable joint medium can be provided between these two parts.

Further, it is advantageous for the mounting help to have an edge region projecting over the screw-over ring so that a screwing-on of the screw-over ring is impossible before the mounting help is removed.

The present invention also provides a system for mounting a door handle, which includes a universal three-part rosette according to the present invention, a mounting help according to the present invention, and through screw joints for joining a pair of the rosette to a door leaf. This system can be sold as a separate kit or together with door handle or other necessary door hardware.

Further advantages and embodiments of the invention can be seen from the detailed description and the associated drawings.

### BRIEF DESCRIPTION OF THE DRAWINGS

The present invention is illustrated by way of example and not limitation in the accompanying drawings in which like reference numbers indicate similar parts.

FIG. 1a is a front plan view of the mounting base according to the present invention.

FIG. 1b is a cross-sectional side view of the mounting base as shown in FIG. 1a.

FIG. 1c is a cross-sectional top view of the mounting base as shown in FIG. 1a.

FIG. 2a is a front plan view of the base member according to the present invention.

FIG. 2b is a cross-sectional top view of the base member as shown in FIG. 2a.

FIG. 3a is a front plan view of the screw-over ring according to the present invention.

FIG. 3b is a cross-sectional side view of the screw-over ring as shown in FIG. 3a.

FIG. 4a is a partial cross-sectional view of a screw according to the present invention.

FIG. 4b is a side view of a threaded bush according to the present invention.

FIG. 4c is a top view of the screw as shown in FIG. 4a.

FIG. 5a is a front plan view of the mounting help according to the present invention.

FIG. 5b is a cross-sectional side view of the mounting help according to the present invention

FIG. 6 is an exploded view of the system for mounting a door handle according to the present invention.

### DETAILED DESCRIPTION OF THE INVENTION

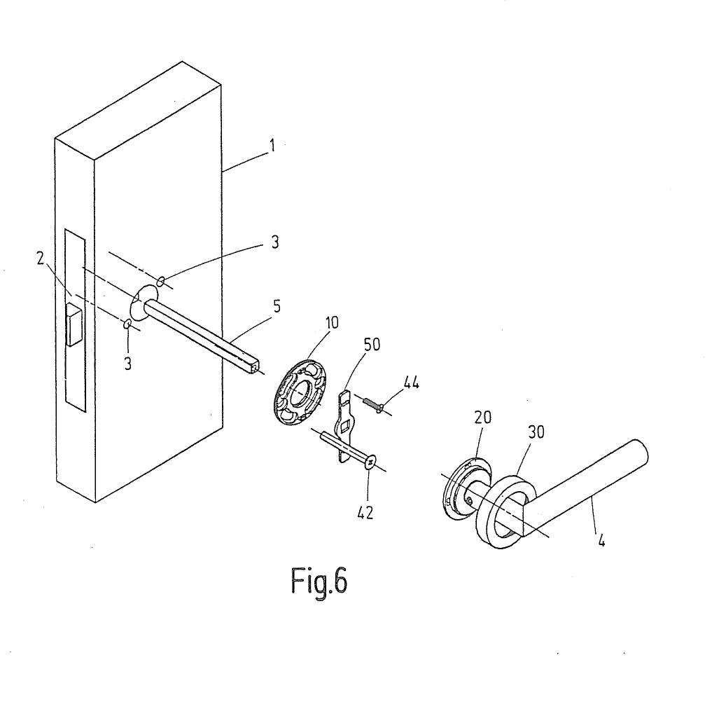

To achieve the object of providing a universal three-part rosette, the mounting base 10 of the present invention has been modified against EP 0 942 121 B1 in that the mounting tappets formed on the side facing the door 1 are omitted so that the mounting base 10 has a planar surface on the side facing the door (see FIG. 6). In this way, the mounting base 10 can be attached to different locks 2 without interference with the angels and distances of the bores 3 in the locks 2 (see FIG. 6).

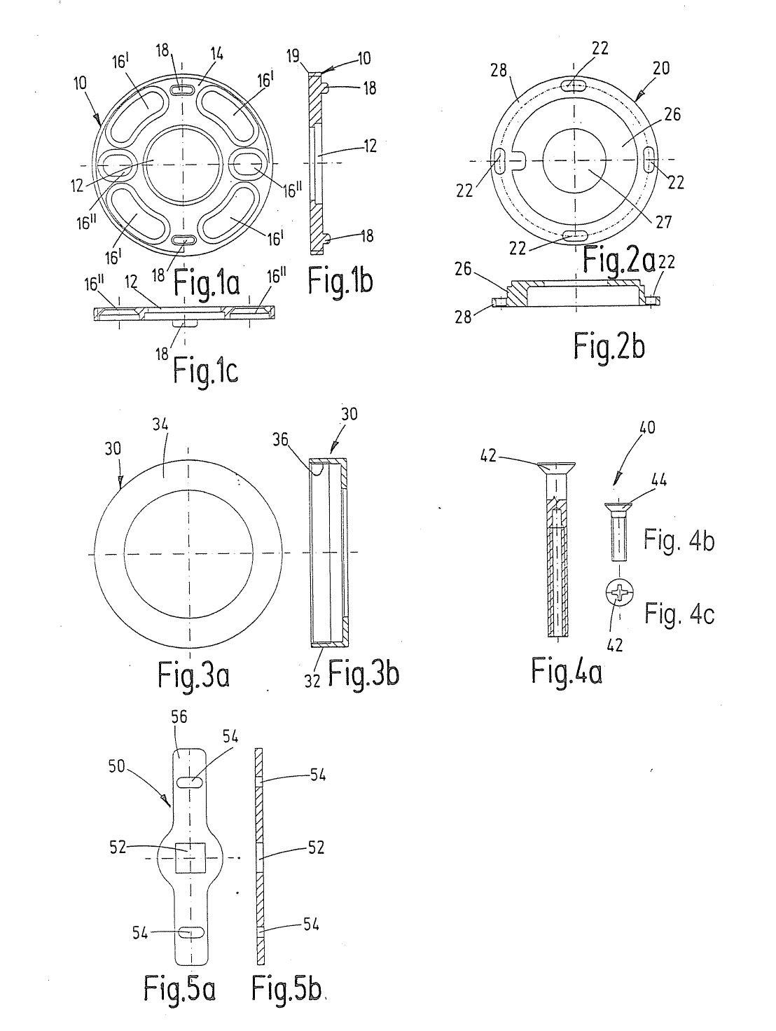

The mounting base 10 has a central opening 12 and a ring part 14 surrounding the central opening 12. In order to be able to use one component for different bore arrangements 3, there provided not only two circular screw openings as in EP 0 942 121 B1, but rather a plurality of screw openings 16′, 16″ in the ring part 14 (see FIG. 1a), which allows different possible through screwing in a range of angles. These screw openings 16′, 16″ are minor symmetrically arranged with respect to the central opening 12 in order to make a both-sided mounting onto the door leaf possible. The fixing is as in EP 0 942 121 B1 through screw connection, which connects two mounting bases to each other. Stop pins 18, which are diametrically opposite, are formed on the ring part 14 of the mounting base 10 and extend axially (see FIGS. 1b and 1c). These stop pins 18 allow the base member 20 (see FIG. 2a) to be attached in a non-rotating position in the same function as the circular pins in EP 0 942 121 B1.

In order to be able to arrange the two stop pins 18 vertically or horizontally in their connecting line, the base member 20 no longer has only two accommodation openings as in EP 0 942 121 B1; rather it has four openings 22 offset 90° with one another so that the base member 20 with its stop brake 24 can always be attached correctly (see FIG. 2a). In this way, the stop brake 24 can always be so oriented that the door handle is arranged horizontally.

As can be seen in FIGS. 2a and 2b, the base member 20 has a central protruding part 26 and an outer ring part 28 surrounding the central protruding part 26. The four openings 22 are formed in the ring part 28. The central protruding part 26 has a central opening 27 corresponding to the central opening 12 of the mounting base 10. The external diameter of the ring part 28 of the base member 20 is slightly smaller than that of the ring part 14 of the mounting base 10.

The stop pins 18 according to the present invention are no longer circular, but rather oblong in the peripheral direction, in order to obtain a higher strength against rotation loads, thus providing better stability.

The mounting base 10 has at least one small through opening 16″ for the vertical or horizontal alignment and at least one arch-shaped elongated opening 16′ for the angular alignment. In the embodiment shown in FIG. 1a, two small through openings 16″ and four arch-shaped elongated openings 16′ are provided. The elongated opening 16′ covers an angular region of preferred 30° to 60°. The interconnect webs between the openings 16′, 16″ guarantee the required strength of the component.

The widths of the openings 16′, 16″ are so designed that a mounting tolerance for the through screw joints (FIGS. 4a-4c show a screw joint 40 consisting of a screw 42 and a threaded bush 44) is provided. For example, openings having a width of 6 mm are used for 4 mm screws and 5.5 mm threaded bushes.

A screw-over ring 30 (see FIGS. 3a and 3b) is provided for screwing onto the mounting base 10. The screw-over ring 30 has a cylindrical part 32 and an annual strip 34 extending radially inwards from the cylindrical part 32. The cylindrical part 32 is formed with an internal screw thread 36 (see FIG. 3b) that corresponds to an external thread 19 (see FIG. 1b) formed on the peripheral side surface of the mounting base 10. The internal diameter of the annual strip 34 corresponds to an external diameter of the central protruding part 26 of the base member 20.

An especially important aspect of the present invention is to allow a simple centering of the two mounting bases. This is not so easily possible due to the missing tappets. For this purpose, a mounting help with a mounting help body 50 (see FIGS. 5a and 5b) is developed, which centers the mounting base 10 to the square pin 5 in the lock socket in correct positional arrangement (FIG. 6). This means that the mounting help can be placed on the square pin 5 in a certain position and thus can be connected with the mounting base 10 that it fits on the door leaf in the correct turning position and correct centered alignment to the square pin 5. In this position, the screw joint 40 can be fastened and the mounting help can then be removed.

The mounting help body 50 has a central square opening 52 for positively mounting on the square pin sitting in the lock casing. Openings 54 in radial spacing to the central opening 52 are provided for accommodating the stop pins 18 of the mounting base 10 so that these two parts can be connected without additional measure.

In order to additionally enable a transient connection between the mounting help 50 and the mounting base 10, a removable joint medium, preferably in the form of a removable adhesive or for example in the form of a snap-on or tie-clip connection on the peripheral thread 19 of the mounting base 10, can be provided between these two parts.

FIG. 6 is an exploded view showing the system for mounting a door handle 4 according to the present invention.

Further, it is advantageous when the mounting help 50 has an edge region 56 projecting over the screw-over ring 30 so that a screwing-on of the screw-over ring 30 is impossible before the mounting help 50 is removed.

While the invention has been described by reference to a specific embodiment chosen for purposes of illustration, it should be apparent that numerous modifications could be made thereto by those skilled in the art without departing from the spirit and scope of the invention.

1. A universal rosette for mounting a door handle, comprising:
a mounting base (10) adapted to be attached to a door leaf, the mounting base having a planar surface on a first side facing the door leaf, a central opening (12), a ring part (14) surrounding the central opening (12), a plurality of screw openings (16′, 16″) with different shapes formed in the ring part (14), and two stop pins (18) formed on the ring part (14) on a second side opposite to the first side;
a base member (20) adapted to be attached to the mounting base (10), the base member having accommodation openings (22) for accommodating the stop pins (18); and
a screw-over ring (30) for screwing onto the mounting base (10).

2. The rosette according to claim 1, wherein the screw openings (16′, 16″) include at least one small through opening (16″) for a vertical or horizontal alignment and at least one arch-shaped elongated opening (16′) for an angular alignment.

3. The rosette according to claim 2, w herein the arch-shaped elongated opening (16′) covers an angular region of preferred 30° to 60°.

4. The rosette according to claim 1, wherein the widths of the screw openings (16′, 16″) are so designed that a mounting tolerance for a through screw joint (40) is provided.

5. The rosette according to claim 1, wherein the screw openings (16′, 16″) are mirror symmetrically arranged with respect to the central opening (12).

6. The rosette according to claim 1, wherein the stop pins (18) are oblong in the peripheral direction.

7. The rosette according to claim 1, wherein the base member (20) has four accommodation openings (22) offset 90° with one another.

8. The rosette according to claim 1, wherein the base member (20) further has a stop brake (24).

9. A mounting help for assisting a mounting of a universal rosette including a mounting base (10) adapted to be attached to a door leaf, the mounting base having a planar surface on a first side facing the door leaf, a central opening (12), a ring part (14) surrounding the central opening (12), a plurality of screw openings (16′, 16″) with different shapes formed in the ring part (14), and two stop pins (18) formed on the ring part (14) and on a second side opposite to the first side; a base member (20) adapted to be attached to the mounting base (10), the base member having accommodation openings (22) for accommodating the stop pins (18); and a screw-over ring (30) for screwing onto the mounting base (10), the mounting help comprising:
a mounting help body (50) being formed with a central square opening (52) for positively mounting on a square pin sitting in a lock casing and two openings (54) in radial spacing to the central opening (52) for accommodating the stop pins (18) of the mounting base (10).

10. The mounting help according to claim 9, wherein a removable joint medium is provided between the mounting help body (50) and the mounting base (10).

11. The mounting help according( to claim 10, wherein the removable joint medium is at least one of a removable adhesive or a snap-on or tie-clip connection on an peripheral thread of the mounting base (10).

12. The mounting help according to claim 9, wherein the mounting help body (50) has an edge region (56) extending over the screw-over ring (30).

13. A system for mounting a door handle, comprising:
a universal rosette including a mounting base (10) adapted to be attached to a door leaf, the mounting base having a planar surface on a first side facing the door leaf, a central opening (12), a ring part (14) surrounding the central opening (12), a plurality of screw openings (16′, 16″) with different shapes formed in the ring part (14), and two stop pins (18) formed on the ring part (14) and on a second side opposite to the first side; a base member (20) adapted to be attached to the mounting base (10), the base member having accommodation openings (22) for accommodating the stop pins (18); and a screw-over ring (30) for screwing onto the mounting base (10);
a mounting help including a mounting help body (50) being formed with a central square opening (52) for positively mounting on a square pin sitting in a lock casing and two openings (54) in radial spacing to the central opening (52) for accommodating the stop pins (18) of the mounting base (10); and
through screw joints (40) for joining a pair of the rosette to a door leaf.
